(19) United States
(12) Patent Application Publication
(10) Pub. No.: US 2017/0267874 A1
(43) Pub. Date: Sep. 21, 2017

(54) ELECTRODEPOSITION COATED ARTICLE AND METHOD FOR PRODUCING SAME

(71) Applicants: MITSUBISHI MATERIALS CORPORATION, Tokyo (JP); Mitsubishi Cable Industries, Ltd., Tokyo (JP)

(72) Inventors: Shintaro Iida, Naka-shi (JP); Hideaki Sakurai, Naka-shi (JP); Hiroyuki Kamibayashi, Arida-shi (JP); Toyokazu Nagato, Arida-shi (JP)

(21) Appl. No.: 15/505,157

(22) PCT Filed: Jul. 30, 2015
(86) PCT No.: PCT/JP2015/071600

§ 371 Date: Feb. 20, 2017

(30) Foreign Application Priority Data
Aug. 26, 2014 (JP) 2014-171210

(51) Int. Cl. C09D 5/44; C25D 13/16; C25D 13/04; H01B 3/30; C09D 179/08

(52) U.S. Cl. CPC C09D 5/4461; H01B 3/306; C09D 179/08; C25D 13/04; C25D 13/16

(57) ABSTRACT

A method for producing an electrodeposition coated article, in which an insulating film is formed by forming an insulating layer on a surface of an article to be coated according to an electrodeposition method by using an electrodeposition coating material, and then by performing a baking treatment, the electrodeposition coating material contains a solvent containing polyamide imide and an organic solvent added to the electrodeposition coating material, a boiling point of the organic solvent is higher than 100° C., and a Hansen solubility parameter is similar to the polyamide imide and has high compatibility.

### TECHNICAL FIELD

The present invention relates to an electrodeposition coated article in which an article to be coated is coated with polyamide imide by electrodeposition coating, and a method for producing the same. Furthermore, priority is claimed on Japanese Patent Application No. 171210 filed on Aug. 26, 2014 (JP2014-171210), the content of JP2014-171210 is incorporated herein by reference.

### BACKGROUND ART

Conventionally, dip coating in which an article to be coated is dipped in a coating material and then is pulled up, and after that, the coating material is dried, and coating is repeated until a predetermined insulating film thickness is obtained, or electrodeposition coating in which a current is allowed to pass through an electrodeposition coating material by inserting an electrode into the electrodeposition coating material, coating material particles are deposited on a rectangular conductive wire which is set to an anode, a formed insulating film is half-cured and rolled, and then, is cured, and thus, an insulating conductive wire is formed is performed as a method of forming an insulating film on a sectional rectangular (hereinafter, also simply referred to as “rectangular”) conductive wire (for example, refer to Patent Document 1). On the other hand, a method is disclosed as the electrodeposition coating in which a rectangular conductive wire is allowed to pass through an electrodeposition layer filled with an electrodeposition coating material, and then, is allowed to pass through a solvent layer filled with an organic solvent or mist or steam of an organic solvent, and after that, is baked, and thus, an insulating film is formed (for example, refer to Patent Document 2). Further, a method of generating mist of an organic solvent by a ultrasonic wave or a method of spraying steam of an organic solvent from an ejection nozzle is disclosed as a method of electrodeposition coating a rectangular conductive wire with an electrodeposition coating material, and then, of spraying an organic solvent (for example, refer to Patent Documents 3 and 4).

### PRIOR ART DOCUMENTS

### Patent Documents

[Patent Document 1] Japanese Unexamined Patent Application Publication No. H03-159014 (Right Column on Page 1 to Upper Right Column on Page 2)

[Patent Document 2] Japanese Unexamined Patent Application Publication No. H03-241609 (Lower Left Column on Page 4 to Upper Left Column on Page 5)

[Patent Document 3] Japanese Examined Patent Application Publication No. H04-065159 (Left Column on Page 2)

[Patent Document 4] Japanese Unexamined Patent Application Publication No. 2012-160304 (Paragraph [0006])

### SUMMARY OF THE INVENTION

### Problems to be Solved by the Invention

However, in the conventional dip coating described in the Patent Document 1 mentioned above, it is difficult to attach the coating material to a corner portion of the rectangular conductive wire, uneven coating occurs, or the coating is required to be repeated many times in order to obtain a predetermined insulating film thickness, and in the electrodeposition coating, an electric field is concentrated on the corner portion of the rectangular conductive wire, and thus, the insulating film on the corner portion becomes thick, or rolling is required to be performed in a half-cured state. On the other hand, in the conventional method of allowing the rectangular conductive wire to pass through the organic solvent described in the Patent Document 2 mentioned above, an insulating film not having a pinhole is obtained with an equal thickness of insulating film, but even in a case of being dipped in a liquid of the organic solvent, the liquid does not penetrate into a gap between resin fine particles due to a surface tension, and thus, it is not possible to perform sufficient dissolution, or it is difficult to control the temperature or the amount of the organic solvent in the steam or the mist. Further, in the conventional methods of generating the mist of the organic solvent by the ultrasonic wave or the method of spraying the steam of the organic solvent from the ejection nozzle described in the Patent Documents 3 and 4 mentioned above, it is possible to adjust the temperature or the amount of the organic solvent, but a complicated device configuration such as a ultrasonic wave generating device, a steam spraying device using a nozzle, and other control devices is required to be controlled, there is a concern that the organic solvent is discharged into the air and affects a human body, and thus, fire protection is required to be considered.

An object of the present invention is to provide an electrodeposition coated article in which an insulating film does not have a pinhole and insulating properties are excellent. Another object of the present invention is to provide a method for producing an electrodeposition coated article in which it is possible to simply form an insulating film having a flat surface without any pinhole in a safe environment.

### Means for Solving Problems

As a result of intensive studies for attaining the objects described above, the inventors have found that in a case where a base material is coated with an insulating film by electrodeposition coating, an organic solvent having high polyamide imide solubility is added to an electrodeposition coating material containing polyamide imide, and the electrodeposition coating is performed, and thus, it is possible to form an insulating film having a flat surface without any pinhole, and thus, the present invention has been completed.

The first viewpoint of the present invention is a method for producing an electrodeposition coated article, in which an insulating film is formed by forming an insulating layer on a surface of an article to be coated according to an electrodeposition method by using an electrodeposition coating material, and then by performing a baking treatment, in which the electrodeposition coating material contains a solvent containing polyamide imide and an organic solvent added to the electrodeposition coating material, and a boiling point of the organic solvent is higher than 100° C., and a relationship of D_{(S-P)}<6 is satisfied, D_{(S-P)} being represented by an expression described below.

D_{(S-P)}=[(dD^{S}−dD^{P})²+(dP^{S}−dP^{P})^{S}+(dH^{S}−dH^{P})²]^{1/2} (1)

Here, dD^{S} is a dispersion component of a Hansen solubility parameter (HSP) value of an organic solvent, dD^{P} is a dispersion component of an HSP value of polyamide imide, dP^{S} is a polarization component of an HSP value of an organic solvent, dP^{P} is an polarization component of an HSP value of an polyamide imide, dH^{S} is a hydrogen bonding component of an HSP value of an organic solvent, and dH^{P} is a hydrogen bonding component of an HSP value of polyamide imide. HSP (dD, dP, and dH) is a value intrinsic to a substance, and compatibility is high among the substances with the close values to one another. It is possible to calculate the value from a molecular structure and to estimate the value by a method of a second viewpoint of the present invention described below even in a case where the molecular structure of the substance is not known.

The second viewpoint of the present invention is an invention based on the first viewpoint, wherein a case in which a mixed liquid of the polyamide imide and the organic solvent becomes transparent is set to an organic solvent having solubility with respect to the polyamide imide, a case in which a mixed liquid of the polyamide imide and the organic solvent becomes opaque is set to an organic solvent not having solubility with respect to the polyamide imide, dD^{S}, dP^{S}, and dH^{S} of the organic solvent are formed into a three-dimensional graph, a center of a minimum sphere on which all points indicating the organic solvent having solubility with respect to the polyamide imide enter is estimated as dD^{P}, dP^{P}, and dH^{P} of the polyamide imide, and an organic solvent satisfying the relationship of D_{(S-P)}<6 is selected.

The third viewpoint of the present invention is an invention based on the first viewpoint or the second viewpoint, wherein the electrodeposition coating material is water dispersible or water soluble, and the organic solvent is a hydrophilic solvent.

The fourth viewpoint of the present invention is an invention based on the first viewpoint to the third viewpoint, wherein the organic solvent is N,N-dimethyl acetamide, N,N-dimethyl formamide, propylene carbonate, dimethyl sulfoxide, 4-butyrolactone, or N-methyl-2-pyrrolidone.

The fifth viewpoint of the present invention is an invention based on the first viewpoint to the fourth viewpoint, wherein the article to be coated is a copper wire.

The sixth viewpoint of the present invention is an electrodeposition coated article, in which in an insulating film formed on a surface of an article to be coated, the number of pinholes on a film sectional surface measured by being observed with SEM is less than or equal to 50 items/10 μm square, and surface roughness Ra measured according to JISC0601 is less than or equal to 40 nm.

The seventh viewpoint of the present invention is an invention based on the sixth viewpoint, the article to be coated is a copper wire.

### Effects of Invention

In the first viewpoint of the present invention, the organic solvent is added to the electrodeposition coating material which is a solvent containing polyamide imide, and thus, a tank of an organic solvent, a device of generating and spraying mist and steam, and a control device are not required, and the organic solvent is not formed into the steam or the mist, and thus, it is possible to simply produce in a safe environment by decreasing a concern that the organic solvent is discharged into the air. Next, the boiling point of the organic solvent is 100° C. or higher, and thus, even in a case where a temperature in a baking step becomes 100° C. or higher, and the moisture of the electrodeposition coating material is evaporated, the organic solvent remains. Therefore, it is possible to expect a swelling and dissolving effect of polyamide imide with respect to a resin due to the organic solvent for a long period of time. Further, solubility of the organic solvent with respect to polyamide imide is defined by an expression of D_{(S-P)}<6 by using a Hansen solubility parameter. In a case where an organic solvent having low compatibility with respect to polyamide imide is added, it is difficult for organic solvent molecules to enter a polymer chain forming polyamide imide particles, and a state is not formed in which the polymer chain is released, and thus, film formability is not improved, and a crack or a pinhole may be generated. However, the organic solvent having high compatibility with respect to polyamide imide is selected and added by the prescribed conditions described above, and thus, the polyamide imide particles are in a swollen state, that is, the organic solvent molecules enter the polymer chain forming the polyamide imide particles, the state is formed in which the polymer chain is released, and the polyamide imide particles are easily fused together at the time of performing thermal curing, and film formability is improved. Therefore, it is possible to produce an electrodeposition coated article including a flat insulating film having excellent insulating properties without any crack or any pinhole.

In the second viewpoint of the present invention, a case in which the mixed liquid of the polyamide imide and the organic solvent becomes transparent is set to the organic solvent having solubility with respect to the polyamide imide, a case in which a mixed liquid of the polyamide imide and the organic solvent becomes opaque is set to an organic solvent not having solubility with respect to the polyamide imide, dD^{S}, dP^{S}, and dH^{S} of the organic solvent are formed into the three-dimensional graph, the center of the minimum sphere on which all of the points indicating the organic solvent having solubility with respect to a polymer enter is estimated as dD^{P}, dP^{P}, and dH^{P} of the polyamide imide, and it is possible to select the organic solvent satisfying the relationship of D_{(S-P)}<6.

In the third viewpoint of the present invention, the electrodeposition coating material is water dispersible or water soluble, and the organic solvent is the hydrophilic solvent, and thus, the electrodeposition coating material and the organic solvent become substances which are dispersed or dissolved in water. Therefore, it is possible to reliably form an insulating film on a surface to be coated.

In the fourth viewpoint of the present invention, N,N-dimethyl acetamide, N,N-dimethyl formamide, propylene carbonate, dimethyl sulfoxide, 4-butyrolactone, or N-methyl-2-pyrrolidone is used as the organic solvent, and thus, it is possible to form an insulating film having an even surface with few pinholes or without any pinhole, in particular, with respect to an epoxy polymer and an acrylic polymer.

In the fifth viewpoint of the present invention, it is possible to form an insulating copper wire in which the insulating film has few pinholes or does not have a pinhole.

In the sixth viewpoint of the present invention, it is possible to provide an electrodeposition coated article including the insulating film with few pinholes or without any pinhole in which insulating properties are excellent, and it is possible to maintain insulating performance even in a rigorous environment where irradiation of an electron beam, a cosmic ray, an ultraviolet ray, and the like is strictly performed.

In the seventh viewpoint of the present invention, it is possible to provide an insulating copper wire in which the insulating film has few pinholes or does not have a pinhole, insulating properties are excellent, and it is possible to maintain insulating performance even in a rigorous environment where irradiation of an electron beam, a cosmic ray, an ultraviolet ray, and the like is strictly performed.

### BRIEF DESCRIPTION OF THE DRAWINGS

FIG. 1 is a diagram schematically illustrating an electrodeposition coating device of an embodiment of the present invention.

FIG. 2 is an SEM picture diagram in which a sectional surface of an insulating portion of an insulating copper wire of Example 1 is enlarged.

FIG. 3 is an SEM picture diagram in which a sectional surface of an insulating portion of an insulating copper wire of Comparative Example 1 is enlarged.

### Embodiments to Carry Out the Invention

Next, an embodiment of the present invention will be described on the basis of the drawings.

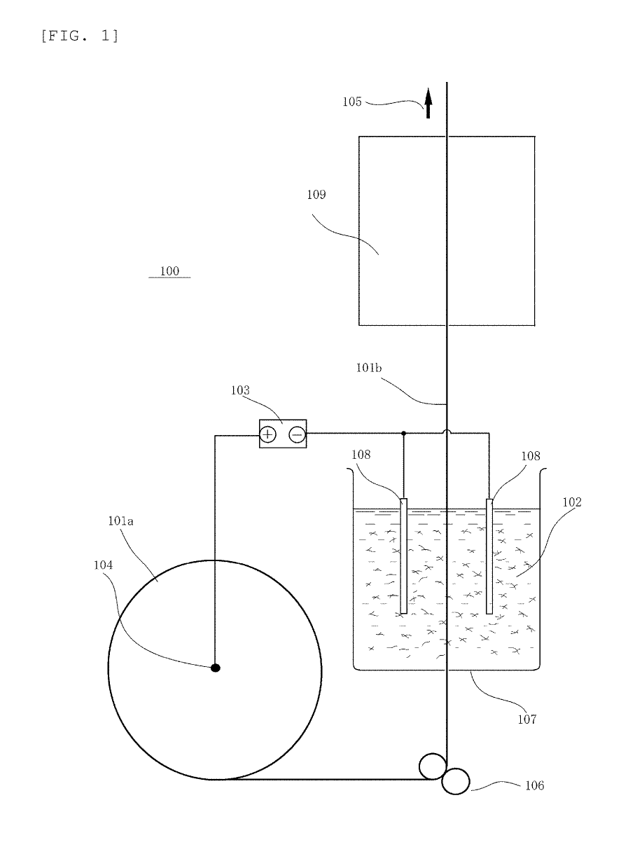

As illustrated in FIG. 1, the present invention is a method in which a rectangular conductive wire 101b is coated with polyamide imide and an organic solvent by an electrodeposition coating device 100, and the coated rectangular conductive wire 101b is subjected to a heat treatment, and thus, an insulating conductive wire which is an electrodeposition coated article including an insulating film of cured polyamide imide is formed on a surface is produced.

In the characteristic configuration of the present invention, an electrodeposition coating material 102 which is prepared by adding a predetermined organic solvent selected by a selection method using a known Hansen solubility parameter described below to an electrodeposition coating material made from a solvent containing polyamide imide is used as a coating material of an electrodeposition coating device 100. Thus, the electrodeposition coating material 102 containing the organic solvent is set to a coating material of electrodeposition coating, and thus, it is possible to simply prepare the electrodeposition coating material 102 which forms a desired insulating film, and it is possible to perform the electrodeposition coating without separately providing a step of applying the organic solvent.

A producing process of an electrodeposition coated article of the present invention will be described in detail with reference to FIG. 1. FIG. 1 illustrates a mode of performing an electrodeposition step, a baking step, and the like continuously in a vertical direction, but it is possible to perform the electrodeposition coating of the present invention by any mode such as a method of performing each step continuously in a horizontal direction or a batch mode of collectively performing one step, and then, of performing the next step.

FIG. 1 is a diagram illustrating an example of a producing process of forming an insulating film on a conductive wire 101 by the electrodeposition coating device 100. An anode 104 which is connected to a positive electrode of a direct current power source 103 is disposed on a conductive wire 101a having a circular sectional surface which is wound into the shape of a cylinder. The circular conductive wire 101a is pulled up in a direction of an arrow 105 and passes through each step. First, as a first step, the circular conductive wire 101a is rolled into the shape of a rectangle through a pair of rolling rollers 106, and thus, the rectangular conductive wire 101b having a rectangular sectional surface is obtained. Next, as a second step, the rectangular conductive wire 101b passes through an electrodeposition tank 107 filled with the electrodeposition coating material 102 in which the organic solvent is added to a solvent containing polyamide imide. In the electrodeposition coating material 102 of the electrodeposition tank 107, a cathode 108 which is connected to a negative electrode of the direct current power source 103 is disposed around the rectangular conductive wire 101b passing through the electrodeposition tank 107. When the rectangular conductive wire 101b passes through the electrodeposition tank 107, a direct current voltage is applied by the direct current power source 103, and dissolved polyamide imide is subjected to electrodeposition on the surface of the rectangular conductive wire 101b. Next, as a third step, the rectangular conductive wire 101b pulled up from the electrodeposition tank 107 passes through a baking furnace 109, and polyamide imide which has been subjected to the electrodeposition is baked on the rectangular conductive wire 101b, and thus, an insulating conductive wire is formed. Furthermore, in this specification, the “insulating conductive wire” indicates a conductive wire in which an insulating film is formed on a surface. Examples of the conductive wire include a copper wire, an aluminum wire, a copper wire, a copper alloy wire, and the like.

It is preferable that the temperature of the electrodeposition coating material 102 is 5° C. to 60° C., a concentration of polyamide imide is 1 to 40% by mass, a direct current voltage is 1 to 300 V, an energizing time is 0.01 to 30 seconds, and a baking temperature is 200° C. to 600° C. Furthermore, in the concentration of the organic solvent, the lower limit is set to the extent of not generating a crack in the insulating film, the upper limit may be set to a value to the extent of not making film formation according to the electrodeposition difficult due to a decrease in conductivity of the electrodeposition coating material, and a range of approximately 1 to 70% by mass is preferable.

Here, the selection method of the organic solvent of the present invention will be described in detail.

First, an organic solvent having a boiling point of higher than or equal to 100° C. is selected as the organic solvent. This is because the electrodeposition coating material containing water and polyamide imide is used, and thus, water is initially evaporated at the time of performing baking, that is, in a case where the organic solvent is evaporated before water, it is not possible to expect the swelling and dissolving effect of polyamide imide due to the organic solvent at the time of performing baking. In the swelling, the organic solvent enters between the polymer chains configuring polyamide imide, and polyamide imide is swollen and gelated, and thus, an effect of improving a viscosity is expected. In addition, the organic solvent enters between the polymer chains, and the polymer chains are rarely bonded to each other, and thus, an effect of dissolving polyamide imide is also expected. This is because polyamide imide is dissolved by the organic solvent, and thus, curing does not to start from an original curing temperature of polyamide imide of 80° C., and even after moisture is evaporated, it is possible to perform baking in a state where polyamide imide which is dissolved without being cured is evenly attached onto the surface of the conductive wire as a fluid.

Next, an organic solvent having excellent solubility with respect to polyamide imide is selected based on a Hansen solubility parameter.

First, polyamide imide powder and various organic solvents are mixed, and thus, a solution including 1% by mass each of polyamide imide and the organic solvent is prepared. Respective solutions are classified into a group of a transparent liquid in which the powder is gelated and a group of an opaque liquid in which the powder is precipitated. Next, a dispersion term dD^{S}, a polarization term dP^{S}, and a hydrogen bonding term dH^{S} of a Hansen solubility parameter of each organic solvent are formed into a three-dimensional graph, a sphere having a minimum radius is prepared such that the group of the transparent liquid is on the inside and the group of the opaque liquid is on the outside, and the center of the sphere is estimated as a Hansen solubility parameter of polyamide imide. An organic solvent in which a value obtained by inputting the estimated Hansen solubility parameter of polyamide imide and the Hansen solubility parameter of the organic solvent into Expression (1) described below is D_{(S-P)}<6 is selected as an organic solvent having excellent solubility with respect to polyamide imide.

D_{(S-P)}=[(dD^{S}-dD^{P})²+(dP^{S}−dP^{P})^{S}+(dH^{S}−dH^{P})²_{]}^{1/2} (1)

Here, dD^{S} is a dispersion component having an HSP value of an organic solvent, dD^{P} is a dispersion component of an HSP value of polyamide imide, dP^{S} is a polarization component of an HSP value of an organic solvent, dP^{P} is an polarization component of an HSP value of an polyamide imide, dH^{S} is a hydrogen bonding component of an HSP value of an organic solvent, and dH^{P} is a hydrogen bonding component of an HSP value of polyamide imide.

### EXAMPLES

Next, examples of the present invention will be described in detail along with comparative examples.

### Example 1

A rectangular copper wire having a width of 2 mm and a thickness of 0.1 mm was set to an anode of electrodeposition, the rectangular copper wire, and an electrodeposition tank was prepared into which an electrodeposition coating material obtained by adding N,N-dimethyl formamide (DMF) of 6% by mass to polyamide imide (water dispersible polyamide imide varnish) of 5% by mass as an organic solvent was put. Next, the rectangular copper wire passed through the electrodeposition tank at a linear velocity of 15 m/min for 2 seconds in a state where a direct current voltage of 5 V was applied, and then, the rectangular copper wire which had been subjected to electrodeposition was allowed to pass through a baking furnace in an atmosphere of 300° C., and was subjected to a baking treatment, and thus, an insulating copper wire having an insulating film thickness of 0.01 mm was prepared.

### Example 2

An insulating copper wire having an insulating film thickness of 0.01 mm was prepared by the same method as that in Example 1 except that the organic solvent was changed to dimethyl sulfoxide (DMSO) of 6% by mass.

### Example 3

An insulating copper wire having an insulating film thickness of 0.01 mm was prepared by the same method as that in Example 1 except that the organic solvent was changed to 4-butyrolactone (4B) of 6% by mass.

### Example 4

An insulating copper wire having an insulating film thickness of 0.01 mm was prepared by the same method as that in Example 1 except that the organic solvent was changed to N-methyl-2-pyrrolidone (NMP) of 6% by mass.

### Example 5

An insulating copper wire having an insulating film thickness of 0.01 mm was prepared by the same method as that in Example 1 except that the organic solvent was changed to DMF of 0.5% by mass.

### Example 6

An insulating copper wire having an insulating film thickness of 0.01 mm was prepared by the same method as that in Example 1 except that the organic solvent was changed to DMF of 50% by mass.

### Comparative Example 1

An insulating copper wire having an insulating film thickness of 0.01 mm was prepared by the same method as that in Example 1 except that the organic solvent was not added, but mist of DMF was added to the rectangular copper wire after the rectangular copper wire passed through the electrodeposition tank.

### Comparative Example 2

An insulating copper wire having an insulating film thickness of 0.01 mm was prepared by the same method as that in Example 1 except that the organic solvent was not added.

### Comparative Example 3

An insulating copper wire having an insulating film thickness of 0.01 mm was prepared by the same method as that in Example 1 except that the organic solvent was changed to formamide of 6% by mass.

### Comparative Example 4

An insulating copper wire having an insulating film thickness of 0.01 mm was prepared by the same method as that in Example 1 except that the organic solvent was changed to acetone of 6% by mass.

### Contrast between Examples and Comparative Examples

In the insulating copper wires obtained in each of the examples and the comparative examples, the number of pinholes was evaluated by an SEM picture, surface roughness Ra was evaluated by a surface step profiler (using a stylus type surface shape measuring instrument manufactured by ULVAC, Inc.), and voltage resistance was evaluated (using an AC voltage resistance tester TOS5000 manufactured by KIKUSUI ELECTRONICS CORP.). The evaluation results are shown in Table 1.

TABLE 1

| | | | | | Evaluation Item | | | |
|---|---|---|---|---|---|---|---|---|
| | Additive | | | | Presence | | | |
| | | Amount | Boiling | | or | Surface | Pinhole | Voltage |
| | | (% by | Point | | Absence | Roughness | (Item/10 μm | Resistance |
| | Type | mass) | (° C.) | D(S-P) | of Crack | Ra (nm) | Square) | (kV) |
| Example 1 | DMF | 6 | 153 | 3.8 | Absent | 50 | 0 | 1.5 |
| Example 2 | DMSO | 6 | 189 | 2.7 | Absent | 40 | 0 | 1.5 |
| Example 3 | 4B | 6 | 204 | 4.5 | Absent | 40 | 0 | 1.5 |
| Example 4 | NMP | 6 | 202 | 2.6 | Absent | 50 | 0 | 1.5 |
| Example 5 | DMF | 0.5 | 153 | 3.8 | Absent | 50 | 0 | 1.5 |
| Example 6 | DMF | 50 | 153 | 3.8 | Absent | 50 | 0 | 1.5 |
| Comparative | DMF Mist | — | 153 | 3.8 | Absent | 250 | 16 | 1.5 |
| Example 1 | Treatment | | | | | | | |
| Comparative | Not being | — | — | — | Present | — | — | — |
| Example 2 | Added | | | | | | | |
| Comparative | Formamide | 6 | 211 | 18.6 | Absent | 200 | 50 | 0.3 |
| Example 3 | | | | | | | | |
| Comparative | Acetone | 6 | 57 | 5.8 | Present | — | — | — |
| Example 4 | | | | | | | | |

In Examples 1 to 6, the insulating copper wires having excellent insulating properties were obtained in which any crack or any pinhole was not generated, the surface roughness was 40 to 50 nm, and the voltage resistance was 1.5 kV.

In Comparative Examples 1 and 3, any crack was not generated, but the surface roughness was 200 to 250 nm, the number of pinholes was 16 to 50 items/10 μm square, and the voltage resistance was 0.3 to 1.5 kV, and thus, each evaluation item had an inferior result, compared to the examples.

In both of Comparative Examples 2 and 4, a crack was generated, and in the other evaluation items, data for comparative evaluation was not obtained.

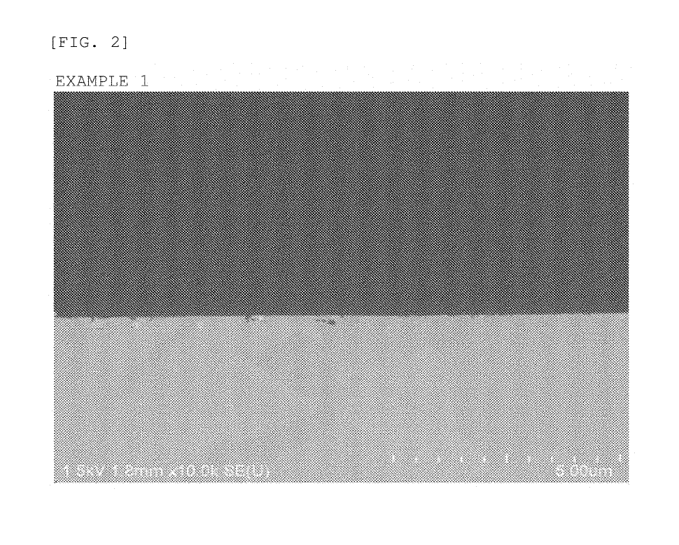

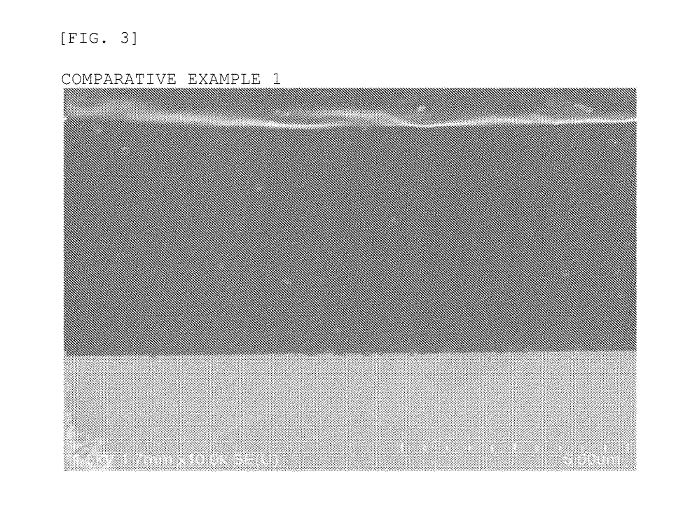

Next, the state of the structure on the sectional surface of the insulating copper wires of Example 1 and Comparative Example 1 was observed by an SEM picture. The SEM picture was imaged by using S-4300SE manufactured by Hitachi, Ltd. The results are illustrated in FIG. 2 and FIG. 3.

As illustrated in FIG. 2 and FIG. 3, in Example 1, any pinhole was not observed, whereas in Comparative Example 1, a plurality of pinholes were observed.

From the results described above, it was confirmed that electrodeposition baking is performed by using the electrodeposition coating material simply prepared by using the organic solvent which had a boiling point of higher than or equal to 100° C. and was selected by the Hansen solubility parameter, and thus, it was possible to obtain an insulating copper wire including an insulating film which had a dense and smooth surface and high voltage resistance without any pinhole in a safe producing environment.

### INDUSTRIAL APPLICABILITY

It is possible to use the electrodeposition coated article of the present invention in a personal computer, a power inductor for a power source of a smart phone, a transformer of an on-vehicle inverter, and the like.

### EXPLANATION OF REFERENCE NUMERALS

102: electrodeposition coating material

1. A method for producing an electrodeposition coated article, in which an insulating film is formed by forming an insulating layer on a surface of an article to be coated according to an electrodeposition method by using an electrodeposition coating material, and then by performing a baking treatment,
wherein the electrodeposition coating material contains a solvent containing polyamide imide and an organic solvent added to the electrodeposition coating material, and
a boiling point of the organic solvent is higher than 100° C., and a relationship of D_{(S-P)}<6 is satisfied, D_{(S-P)} being represented by an expression described below,
D_{(S-P)}=[(dD^{S}−dD^{P})²+(dP^{S}−dP^{P})²+(dH^{S}−dH^{P})²]^{1/2} (1)
in the expression, dD^{S} is a dispersion component of an HSP value of an organic solvent, dD^{P} is a dispersion component of an HSP value of polyamide imide, dP^{S} is a polarization component of an HSP value of an organic solvent, dP^{P} is an polarization component of an HSP value of an polyamide imide, dH^{S} is a hydrogen bonding component of an HSP value of an organic solvent, and dH^{P} is a hydrogen bonding component of an HSP value of polyamide imide.

2. The method for producing an electrodeposition coated article according to claim 1,
wherein a case in which a mixed liquid of the polyamide imide and the organic solvent becomes transparent is set to an organic solvent having solubility with respect to the polyamide imide, a case in which a mixed liquid of the polyamide imide and the organic solvent becomes opaque is set to an organic solvent not having solubility with respect to the polyamide imide, dD^{S}, dP^{S}, and dH^{S} of the organic solvent are formed into a three-dimensional graph, a center of a minimum sphere on which all points indicating the organic solvent having solubility with respect to the polyamide imide enter is estimated as dD^{P}, dP^{P}, and dH^{P} of the polyamide imide, and an organic solvent satisfying the relationship of D_{(S-P)}<6 is selected.

3. The method for producing an electrodeposition coated article according to claim 1,
wherein the electrodeposition coating material is water dispersible or water soluble, and the organic solvent is a hydrophilic solvent.

4. The method for producing an electrodeposition coated article according to claim 1,
wherein the organic solvent is N,N-dimethyl acetamide, N,N-dimethyl formamide, propylene carbonate, dimethyl sulfoxide, 4-butyrolactone, or N-methyl-2-pyrrolidone.

5. The method for producing an electrodeposition coated article according to claim 1,
wherein the article to be coated is a copper wire.

6. An electrodeposition coated article,
wherein in an insulating film formed on a surface of an article to be coated, the number of pinholes on a film sectional surface measured by being observed with SEM is less than or equal to 50 items/10 μm square, and surface roughness Ra measured according to JISC0601 is less than or equal to 40 nm.

7. The electrodeposition coated article according to claim 6,
wherein the article to be coated is a copper wire.

8. The method for producing an electrodeposition coated article according to claim 2,
wherein the electrodeposition coating material is water dispersible or water soluble, and the organic solvent is a hydrophilic solvent.

9. The method for producing an electrodeposition coated article according to claim 2,
wherein the organic solvent is N,N-dimethyl acetamide, N,N-dimethyl formamide, propylene carbonate, dimethyl sulfoxide, 4-butyrolactone, or N-methyl-2-pyrrolidone.

10. The method for producing an electrodeposition coated article according to claim 3,
wherein the organic solvent is N,N-dimethyl acetamide, N,N-dimethyl formamide, propylene carbonate, dimethyl sulfoxide, 4-butyrolactone, or N-methyl-2-pyrrolidone.

11. The method for producing an electrodeposition coated article according to claim 8,
wherein the organic solvent is N,N-dimethyl acetamide, N,N-dimethyl formamide, propylene carbonate, dimethyl sulfoxide, 4-butyrolactone, or N-methyl-2-pyrrolidone.

12. The method for producing an electrodeposition coated article according to claim 2,
wherein the article to be coated is a copper wire.

13. The method for producing an electrodeposition coated article according to claim 3,
wherein the article to be coated is a copper wire.

14. The method for producing an electrodeposition coated article according to claim 4,
wherein the article to be coated is a copper wire.

15. The method for producing an electrodeposition coated article according to claim 8,
wherein the article to be coated is a copper wire.

16. The method for producing an electrodeposition coated article according to claim 9,
wherein the article to be coated is a copper wire.

17. The method for producing an electrodeposition coated article according to claim 10,
wherein the article to be coated is a copper wire.

18. The method for producing an electrodeposition coated article according to claim 11,
wherein the article to be coated is a copper wire.
